(19) United States
(12) Patent Application Publication
(10) Pub. No.: US 2018/0194406 A1
(43) Pub. Date: Jul. 12, 2018

(54) VEHICLE FRONT STRUCTURE

(71) Applicant: TOYOTA JIDOSHA KABUSHIKI KAISHA, Toyota-shi (JP)

(72) Inventors: Akihiko IKEDA, Miyoshi-shi (JP); Fumiaki SHIGEMATSU, Gamagori-shi (JP)

(73) Assignee: TOYOTA JIDOSHA KABUSHIKI KAISHA, Toyota-shi (JP)

(21) Appl. No.: 15/848,752

(22) Filed: Dec. 20, 2017

(30) Foreign Application Priority Data
Jan. 10, 2017 (JP) 2017-001980

(51) Int. Cl. B62D 25/08; B62D 21/15

(52) U.S. Cl. CPC B62D 25/085; B62D 21/152

(57) ABSTRACT

A vehicle front structure includes a powertrain unit disposed in a front portion of a vehicle; and a vehicle body member disposed behind the powertrain unit and extending in a vehicle width direction. The powertrain unit is provided with a contact portion having a contact surface that contacts a receiving surface of the vehicle body member at a time when the powertrain unit moves backward during a vehicle front collision, the receiving surface being planar. The contact surface of the contact portion is planar and is inclined with respect to the receiving surface in a same direction as a direction in which the receiving surface is inclined due to deformation of the vehicle body member during the vehicle front collision.

### The disclosure of Japanese Patent Application No. 2017-001980 filed on Jan. 10, 2017 including the specification, drawings and abstract is incorporated herein by reference in its entirety.

### BACKGROUND

### 1. Technical Field

The disclosure relates to a vehicle front structure. In particular, the disclosure relates to improvement for enhancing an effect of suppressing backward movement of a powertrain unit during a vehicle front collision (during a frontal collision).

### 2. Description of Related Art

It has been conventionally known that, when a powertrain unit (for example, a unit configured by including an engine, a transaxle, and the like in a vehicle with a front-engine, front-wheel-drive (FF) layout) moves toward a vehicle rear side (i.e., the powertrain unit moves backward) due to a collision load during a vehicle front collision, this powertrain unit contacts a vehicle body member (hereinafter may also be referred to as a cross member) that is disposed behind the powertrain unit and extends in a vehicle width direction. For example, Japanese Patent Application Publication No. 2016-112956 (JP 2016-112956 A) describes that a contact surface (a hitting surface) is provided at a rear end of the powertrain unit, a receiving surface is provided at a front end of the cross member, and the contact surface of the powertrain unit that moves backward contacts the receiving surface of the cross member during the vehicle front collision. Thus, an amount of backward displacement of the powertrain unit is reduced.

### SUMMARY

However, there is a case that the receiving surface of the cross member is inclined, during the vehicle front collision, due to deformation of a front body portion. For example, there is a case where this receiving surface is inclined obliquely downward.

In a structure described in JP 2016-112956 A, the contact surface of the powertrain unit and the receiving surface of the cross member are configured to be substantially parallel to each other in advance (the contact surface and the receiving surface are substantially parallel to each other with a specified clearance therebetween). Thus, in the case where the receiving surface of the cross member is inclined, the contact surface of the powertrain unit locally contacts the receiving surface of this cross member. In such a situation, a surface-contact area between the receiving surface of the cross member and the contact surface of the powertrain unit is reduced, and a local deformation amount is increased. Thus, the powertrain unit is more likely to slip away from the cross member (is more likely to slip rearward in the vehicle), and an amount of load absorption performed by the cross member is reduced.

The disclosure provides a vehicle front structure that allows a vehicle body member (a cross member) to effectively absorb a load and thus can enhance an effect of suppressing backward movement of a powertrain unit.

An aspect of the disclosure relates to a vehicle front structure including a powertrain unit disposed in a front portion of a vehicle; and a vehicle body member disposed behind the powertrain unit and extending in a vehicle width direction. The powertrain unit is provided with a contact portion having a contact surface that contacts a receiving surface of the vehicle body member at a time when the powertrain unit moves backward during a vehicle front collision, the receiving surface being planar. The contact surface of the contact portion is planar and is inclined with respect to the receiving surface in a same direction as a direction in which the receiving surface is inclined due to deformation of the vehicle body member during the vehicle front collision.

With this configuration, the contact surface of the contact portion is inclined with respect to the receiving surface in the same direction as the direction in which the receiving surface is inclined due to the deformation of the vehicle body member during the vehicle front collision. Accordingly, even in a situation where the receiving surface of the vehicle body member is inclined due to deformation of a front body portion of the vehicle caused by a collision load during the vehicle front collision, the receiving surface after the deformation of the vehicle body member becomes substantially parallel to the contact surface of the contact portion of the powertrain unit, and a large surface-contact area between the surfaces can be secured. Thus, it is possible to avoid a situation where only a local portion of the contact surface of the contact portion contacts the receiving surface of the vehicle body member. Accordingly, the powertrain unit is less likely to slip away from the vehicle body member. Therefore, the load is effectively absorbed by the vehicle body member. As a result, an effect of suppressing the backward movement of the powertrain unit can be enhanced.

The receiving surface of the vehicle body member may extend in a vertical direction; and in a case where the receiving surface is configured to face obliquely downward during the vehicle front collision, the contact surface of the contact portion may be inclined toward the vehicle body member in a downward direction.

With this configuration, the contact surface of the contact portion is inclined toward the vehicle body member in the downward direction. Accordingly, when the vehicle body member is deformed such that the receiving surface faces obliquely downward during the vehicle front collision, the receiving surface of the vehicle body member after the deformation becomes substantially parallel to the contact surface of the contact portion, and thus, the large surface-contact area between these surfaces can be secured. Thus, as described above, it is possible to avoid the situation where only a local portion of the contact surface of the contact portion contacts the receiving surface of the vehicle body member. Accordingly, the powertrain unit is less likely to slip away from the vehicle body member. Therefore, the load is effectively absorbed by the vehicle body member. As a result, the effect of suppressing the backward movement of the powertrain unit can be enhanced.

In the above aspect of the disclosure, the contact surface of the contact portion of the powertrain unit, which contacts the receiving surface of the vehicle body member during the vehicle front collision, is inclined with respect to the receiving surface of the vehicle body member in the same direction as the direction in which the receiving surface is inclined due to the deformation of the vehicle body member during the vehicle front collision. Accordingly, the receiving surface after the deformation of the vehicle body member becomes substantially parallel to the contact surface of the contact portion of the powertrain unit, and the large surface-contact area between the surfaces can be secured. Thus, it is possible to avoid a situation where only a local portion of the contact surface of the contact portion contacts the receiving surface of the vehicle body member. As a result, the powertrain unit is less likely to slip away from the vehicle body member, and the load is effectively absorbed by the vehicle body member. Therefore, the effect of suppressing the backward movement of the powertrain unit can be enhanced.

### BRIEF DESCRIPTION OF THE DRAWINGS

Features, advantages, and technical and industrial significance of exemplary embodiments of the disclosure will be described below with reference to the accompanying drawings, in which like numerals denote like elements, and wherein:

FIG. 1 is a side view illustrating a layout of a powertrain unit and a suspension cross member in a first embodiment;

FIG. 2 is a rear view of the powertrain unit in the first embodiment;

FIG. 3 is a bottom view of the powertrain unit in the first embodiment;

FIG. 4 is a view that corresponds to FIG. 1 and illustrates a time point at which the suspension cross member is deformed during a vehicle front collision;

FIG. 5 is a view that corresponds to FIG. 1 and illustrates a state where the powertrain unit contacts the suspension cross member during the vehicle front collision; and

FIG. 6 is a view that illustrates a second embodiment, and corresponds to FIG. 1.

### DETAILED DESCRIPTION OF EMBODIMENTS

Hereinafter a description will be provided on embodiments of the disclosure on the basis of the drawings. In these embodiments, a description will be provided on a case where the disclosure is applied to a hybrid vehicle with a front-engine, front-wheel-drive (FF) layout.

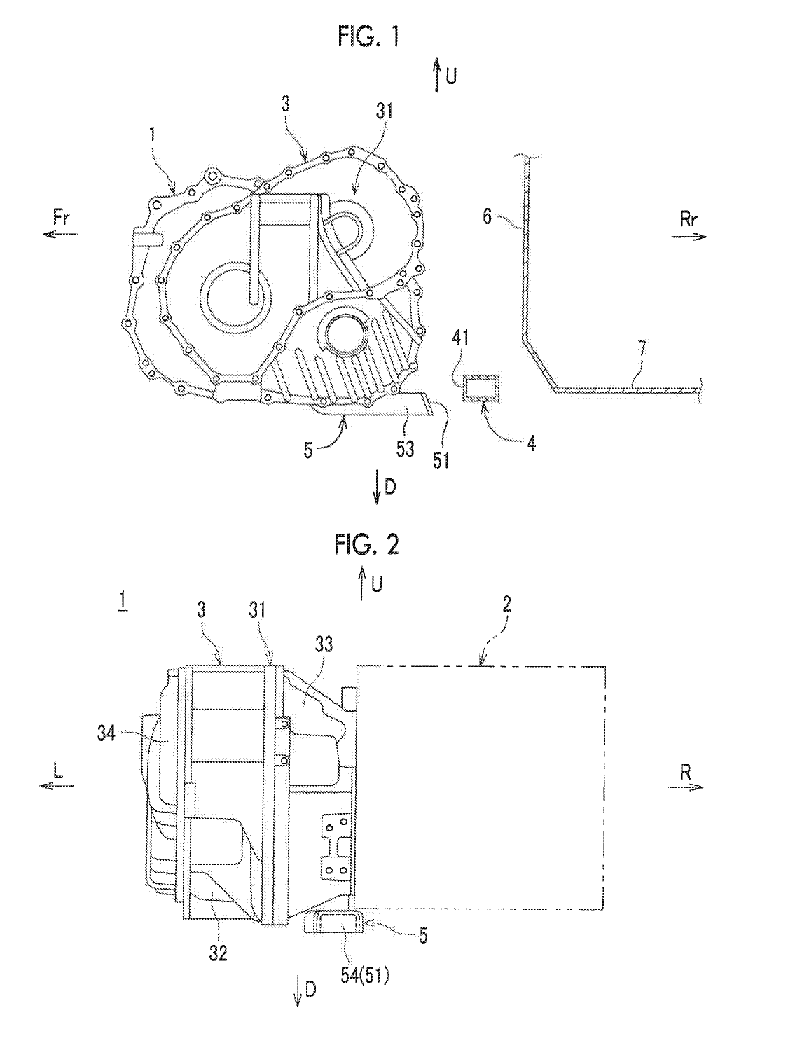

A description will be provided on a schematic structure of a powertrain unit and a suspension cross member in a first embodiment. FIG. 1 is a side view of an arrangement layout of a powertrain unit 1 and a suspension cross member (a vehicle body member) 4 as a vehicle front structure according to this embodiment. In this FIG. 1, an arrow Fr, an arrow Rr, an arrow U, and an arrow D respectively represent a vehicle front side, a vehicle rear side, an upper side, and a lower side. As shown in this FIG. 1, the powertrain unit 1 and the suspension cross member (hereinafter simply referred to as a cross member) 4 are disposed in a front portion of the vehicle, and the cross member 4 is disposed behind this powertrain unit 1 and extends in a vehicle width direction,

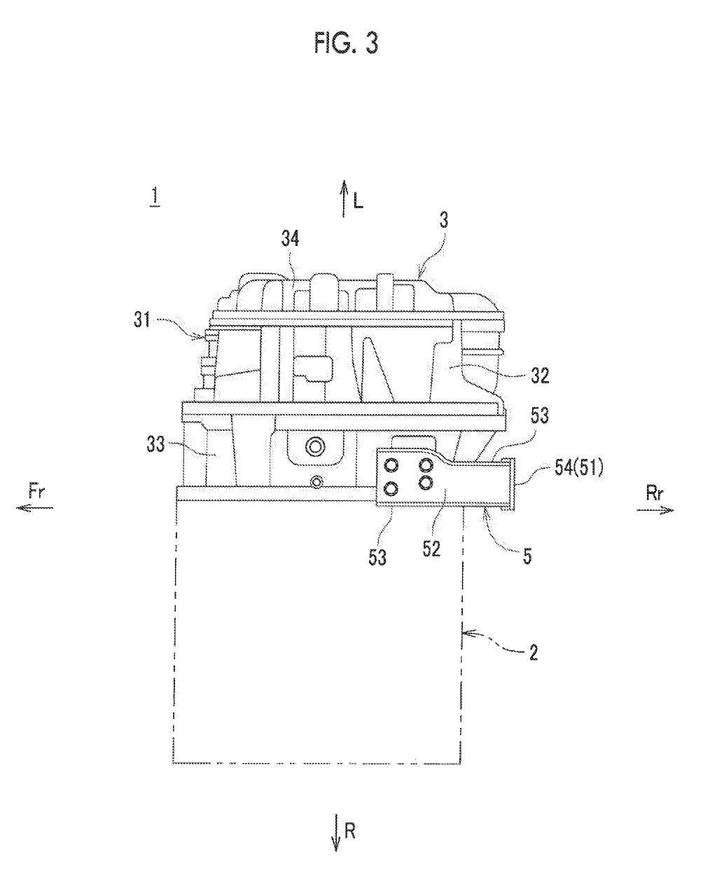

The powertrain unit 1 has a structure in which an engine 2 (see imaginary lines in FIG. 2 and FIG. 3), a transaxle 3, and the like are integrally assembled.

FIG. 2 is a rear view of the powertrain unit 1 (a view that is seen from the vehicle rear side). FIG. 3 is a bottom view of the powertrain unit 1. In these FIG. 2 and FIG. 3, the arrow Fr, the arrow Rr, the arrow U, the arrow D, an arrow R, and an arrow L respectively represent the vehicle front side, the vehicle rear side, the upper side, the lower side, a vehicle right side, and a vehicle left side. As shown in these drawings, in the transaxle 3, a damper, a planetary gear, a generator motor, a travel drive motor, a differential device, and the like, which are not shown, are accommodated in a transaxle case 31. The transaxle case 31 has a structure in which a transaxle case main body 32, a transaxle housing 33, and a cover 34 are integrally assembled. The transaxle housing 33 is attached to one side (a side where the engine 2 is disposed) of the transaxle case main body 32, and the cover 34 is attached to the other side (a side opposite to the side where the engine 2 is disposed) of the transaxle case main body 32. Note that the structure of the transaxle case 31 is not limited to the above-described structure.

As shown by the imaginary lines in FIG. 2 and FIG. 3, the engine 2 is connected to the transaxle housing 33. A four-cylinder gasoline engine is adopted as this engine 2, for example.

As described above, the engine 2 and the transaxle 3 are integrally assembled and constitute the powertrain unit 1. Drive power of the engine 2 that is output from a crankshaft (not shown) of the engine 2 is input to the planetary gear via the damper. The drive power of the engine 2, which has been input to the planetary gear, is divided by this planetary gear and is then transmitted to the generator motor and the differential device.

The cross member 4 is a vehicle body structural member that supports a front-wheel suspension device, which is not shown. The cross member 4 has a rectangular closed cross-section structure, and has high rigidity. This cross member 4 is disposed in a lower part of a space between the powertrain unit 1 and a dash panel (a panel that separates an engine compartment and a vehicle cabin) 6. A height position at which this cross member 4 is disposed is set to be substantially the same as a height position of a floor panel 7 that constitutes a floor surface of the vehicle cabin.

Next, a description will be provided on a structure provided to absorb a collision load during a vehicle front collision as a characteristic of this embodiment. In this load absorption structure, when the powertrain unit 1 moves toward the vehicle rear side (i.e., the powertrain unit 1 moves backward) due to the collision load during the vehicle front collision, this powertrain unit 1 contacts the cross member 4 such that the collision load is absorbed and an amount of backward displacement of the powertrain unit 1 is reduced.

In above-described JP 2016-112956 A, the contact surface provided in the powertrain unit and the receiving surface provided in the cross member are made substantially parallel to each other in advance (the contact surface and the receiving surface are substantially parallel to each other with the specified clearance therebetween). Thus, in the case where the receiving surface of the cross member is inclined due to the deformation of the front body portion during the vehicle front collision, the contact surface of the powertrain unit locally contacts the receiving surface of this cross member. In such a situation, a surface-contact area between the receiving surface of the cross member and the contact surface of the powertrain unit is reduced, and a local deformation amount is increased. Thus, the powertrain unit is more likely to slip away from the cross member, and therefore, the amount of load absorption performed by the cross member is reduced.

In view of the above point, in this embodiment, the cross member 4 effectively absorbs the load, so as to be able to enhance an effect of suppressing the backward movement of the powertrain unit 1. A specific description thereon will be provided below.

As described above, the cross member 4 is configured to have the rectangular closed cross-section structure. A front surface (a surface facing the powertrain unit 1) 41 of this cross member 4 is formed as a plane that extends in a vertical direction. Because the powertrain unit 1 that moves backward contacts the front surface 41 of the cross member 4 during the vehicle front collision, the front surface 41 will hereinafter be referred to as a receiving surface 41.

A contact bracket (a contact portion) 5 is attached to a lower surface of the transaxle housing 33 of the transaxle case 31, and the contact bracket 5 faces the receiving surface 41 of the cross member 4 with a specified clearance therebetween in a vehicle front-rear direction. That is, when the powertrain unit 1 moves backward during the vehicle front collision, a rear surface 51 of this contact bracket 5 contacts the receiving surface 41 of the cross member 4. More specifically, an upper end position of the rear surface 51 of this contact bracket 5 is set to be a lower position than an upper end position of the receiving surface 41 of the cross member 4. Thus, a lower region in the receiving surface 41 of the cross member 4 faces the contact bracket 5 in the vehicle front-rear direction. When the powertrain unit 1 moves straight backward (moves in a horizontal direction) during the vehicle front collision, the rear surface 51 of the contact bracket 5 contacts only the lower region in the receiving surface 41 of the cross member 4. In addition, in the case where relative positions of the powertrain unit 1 and the cross member 4 in the vertical direction are changed, for example, in the case where the powertrain unit 1 moves obliquely upward and toward the vehicle rear side, the rear surface 51 of the contact bracket 5 contacts only an upper region in the receiving surface 41 of the cross member 4. Thus, because the rear surface 51 of the contact bracket 5 contacts the receiving surface 41 of the cross member 4 at the time when the powertrain unit 1 moves backward during the vehicle front collision, the rear surface 51 will hereinafter be referred to as a contact surface 51.

As shown in FIG. 3, the contact bracket 5 is formed by folding a metal plate material. More specifically, this contact bracket 5 includes a base plate portion 52 that is fixed to the lower surface of the transaxle housing 33 by bolts; side plate portions 53 that extend downward from both sides (both sides in the vehicle width direction) of this base plate portion 52; and a contact plate portion 54 that extends downward from an end in a rear side of the base plate portion 52 in a vehicle front-rear direction. A width (a length in the vehicle width direction) of this contact plate portion 54 is set to be slightly greater than a length between outer surfaces of the side plate portions 53. A rear surface of this contact plate portion 54 is the contact surface 51.

The characteristic of this embodiment is a structure of this contact surface 51. This contact surface 51 is inclined toward the cross member 4 in a direction from an upper end to a lower end of the contact surface 51 (i.e., in a downward direction). That is, the contact surface 51 is an inclined surface that is inclined toward the vehicle rear side in the downward direction. A rear end edge of each of the side plate portions 53 of the contact bracket 5 is also inclined toward the cross member 4 in a direction from an upper end to a lower end of the rear end edge (i.e., in the downward direction). A front surface of the contact plate portion 54 is joined to the rear end edge of each of the side plate portions 53 by, for example, welding. An inclination angle of the rear end edge of each of the side plate portions 53, that is, an inclination angle of the contact surface 51 is set at, for example, approximately 70° with respect to the horizontal direction. However, the inclination angle is not limited to this value, and is appropriately set on the basis of an experiment or a simulation. That is, as will be described below, the inclination angle of the contact surface 51 is set to be an angle that corresponds to an angle at which the receiving surface 41 is inclined due to the deformation of the cross member 4 during the vehicle front collision (i.e., the inclination angle of the contact surface 51 is set to be an angle that allows surface contact between the receiving surface 41 and the contact surface 51).

Next, a description will be provided on an operation during the vehicle front collision.

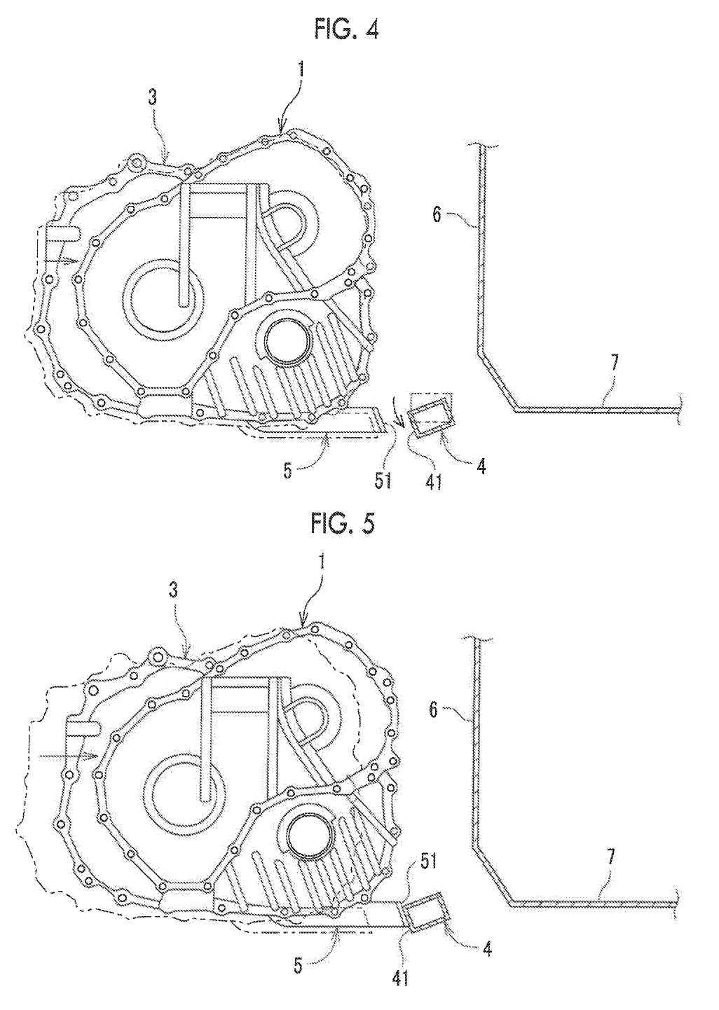

During the vehicle front collision, as shown in FIG. 4 (a drawing that represents a time point at which the cross member 4 is deformed during the vehicle front collision), the cross member 4 is deformed by the collision load such that the receiving surface 41 faces obliquely downward (see an arrow in FIG. 4), that is, the deformation of the front body portion of the vehicle occurs. That is, the cross member 4 is deformed such that the receiving surface 41 that has extended in the vertical direction faces obliquely downward. In reality, while slightly moving downward, the cross member 4 is deformed such that the receiving surface 41 faces obliquely downward. In FIG. 4, a state of the cross member 4 before the deformation is shown by imaginary lines.

In this embodiment, as described above, the contact surface 51 is inclined toward the cross member 4 in the downward direction. Accordingly, the receiving surface 41 of the cross member 4 after the deformation becomes substantially parallel to the contact surface 51 of the contact bracket 5. Then, as shown in FIG. 5, when the powertrain unit 1 moves backward and the contact bracket 5 comes into contact with the cross member 4, these surfaces 41, 51 come in surface contact with each other. That is, because the contact surface 51 of the contact bracket 5 is inclined with respect to the receiving surface 41 of the cross member 4 in the same direction as a direction in which the receiving surface 41 is inclined due to the deformation of the cross member 4 during the vehicle front collision, it is possible to secure the large surface-contact area between the receiving surface 41 of the cross member 4 after the deformation and the contact surface 51 of the contact bracket 5. Thus, it is possible to avoid a situation where only a local portion of the contact surface 51 of the contact bracket 5 contacts the receiving surface 41 of the cross member 4. Accordingly, the powertrain unit 1 is less likely to slip away from the cross member 4. Therefore, the load is efficiently absorbed by the cross member 4. As a result, the effect of suppressing the backward movement of the powertrain unit 1 can be enhanced, and thus an adverse effect on the vehicle cabin, which is caused by the backward movement of the powertrain unit 1, can be suppressed.

Next, a description will be provided on a second embodiment. In the above-described first embodiment, the contact surface 51 of the contact bracket 5 is inclined toward the cross member 4 in the downward direction, taking into account that the cross member 4 is deformed such that the receiving surface 41 faces obliquely downward during the vehicle front collision.

In this embodiment, deformation of the cross member 4 that causes the receiving surface 41 to face obliquely upward during the vehicle front collision is taken into consideration.

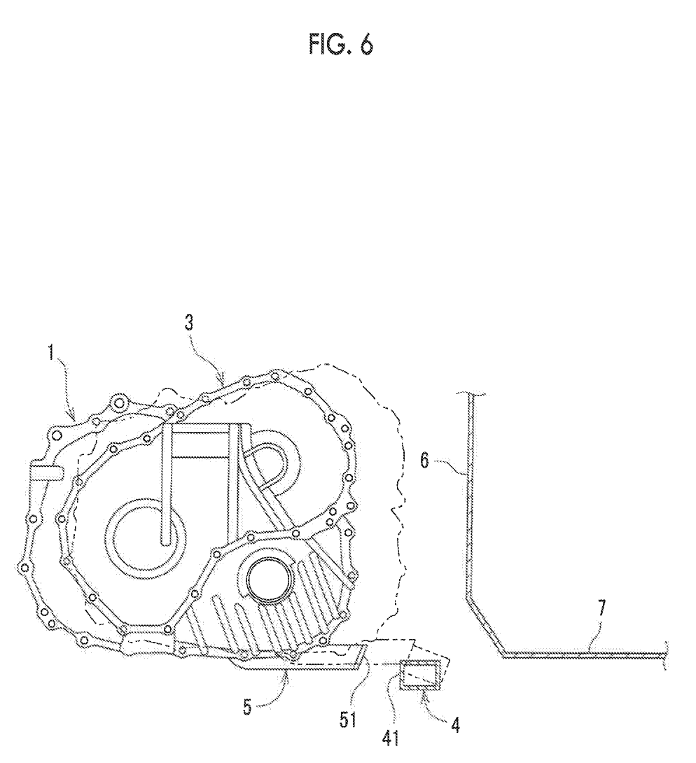

More specifically, as shown in FIG. 6, the contact surface 51 of the contact bracket 5 is inclined toward the cross member 4 in the upward direction. That is, as indicated by an imaginary line in FIG. 6, in the case where the cross member 4 is deformed such that the receiving surface 41 faces upward (obliquely upward), this receiving surface 41 of the cross member 4 after the deformation becomes substantially parallel to the contact surface 51 of the contact bracket 5, and thus the large surface-contact area between these surfaces 41, 51 can be secured.

With this structure as well, similarly to the above embodiment, the load is effectively absorbed by the cross member 4, and the effect of suppressing the backward movement of the powertrain unit 1 can be enhanced.

Next, a description will be provided on other embodiments. The disclosure is not limited to any of the above embodiments, and various modifications may be made to each of the above embodiment within the scope of the disclosure.

For example, in each of the above embodiments, the description has been provided on the case where the suspension cross member 4 is the member with which the powertrain unit 1 comes into contact (the contact bracket 5 comes into contact) at the time when the powertrain unit 1 moves backward during the vehicle front collision. In the disclosure, the member, with which the powertrain unit 1 comes into contact, should not be limited to the suspension cross member 4. The member, with which the powertrain unit 1 comes into contact, may be another member, as long as it is a vehicle body member that is disposed behind the powertrain unit 1 and that extends in the vehicle width direction.

In each of the above embodiments, the description has been provided on the case where the disclosure is applied to the vehicle in which the gasoline engine 2 is provided. However, the disclosure is not limited thereto and can be also applied to a vehicle in which another internal combustion engine such as a diesel engine is provided. In addition, the number of the cylinders and a type (V-type:, horizontally-opposed type, or the like) of the engine are not particularly limited.

In each of the above embodiments, the description has been provided on the case where the disclosure is applied to the hybrid vehicle. However, the disclosure car be also applied to a conventional vehicle (a vehicle in which only the engine is provided as a drive power source).

In each of the above embodiments, the contact bracket 5 is formed by bending the metal plate material. However, the disclosure is not limited thereto. The contact bracket 5 may be formed of a casting or a resin material with required strength such as fiber reinforced plastic (FRP).

The disclosure can be applied to the vehicle front structure that absorbs the load by causing the powertrain unit to contact the cross member during the vehicle front collision and thereby suppresses the backward movement of the powertrain unit.

What is claimed is:

1. A vehicle front structure comprising:
a powertrain unit disposed in a front portion of a vehicle; and
a vehicle body member disposed behind the powertrain unit and extending in a vehicle width direction, wherein
the powertrain unit is provided with a contact portion having a contact surface that contacts a receiving surface of the vehicle body member at a time when the powertrain unit moves backward during a vehicle front collision, the receiving surface being planar, and
the contact surface of the contact portion is planar and is inclined with respect to the receiving surface in a same direction as a direction in which the receiving surface is inclined due to deformation of the vehicle body member during the vehicle front collision.

2. The vehicle front structure according to claim 1, wherein:
the receiving surface of the vehicle body member extends in a vertical direction; and
in a case where the receiving surface is configured to face obliquely downward during the vehicle front collision, the contact surface of the contact portion is inclined toward the vehicle body member in a downward direction.

3. The vehicle front structure according to claim 1, wherein:
the receiving surface of the vehicle body member extends in a vertical direction; and
in a case where the receiving surface is configured to face obliquely upward during the vehicle front collision, the contact surface of the contact portion is inclined toward the vehicle body member in an upward direction.
